(19) United States
(12) Patent Application Publication
(10) Pub. No.: US 2019/0389554 A1
(43) Pub. Date: Dec. 26, 2019

(54) SYSTEMS AND METHODS FOR ENERGY REGENERATION IN A BUOYANT AERIAL VEHICLE

(71) Applicant: LOON LLC, Mountain View, CA (US)

(72) Inventor: Kevin Anderson, Sunnyvale, CA (US)

(73) Assignee: X Development LLC, Mountain View, CA (US)

(21) Appl. No.: 16/013,374

(22) Filed: Jun. 20, 2018

(51) Int. Cl. B64B 1/70; F01D 15/10; B64B 1/40; B64B 1/62

(52) U.S. Cl. CPC B64B 1/70; F01D 15/10; F05D 2220/76; B64B 1/62; B64B 1/40

(57) ABSTRACT

A buoyant aerial vehicle system includes a balloon, a ballonet configured to selectively receive and discharge a gas to adjust an altitude of the balloon, and an energy regeneration assembly. The energy regeneration assembly includes a turbine and an electric motor. The turbine is coupled to an outlet of the ballonet, such that gas released by the bayonet activates the turbine. The electric motor is operably coupled to the turbine and is configured to convert mechanical energy received from the turbine into electrical energy and convey the electrical energy to a battery.

### TECHNICAL FIELD

The present disclosure generally relates to buoyant aerial vehicle systems, and more particularly, to means for conserving energy during flight and operation of buoyant aerial vehicle systems.

### BACKGROUND

Some aerial vehicles may include a balloon having an internally disposed ballonet for adjusting the altitude of the balloon. However, these vehicles typically have substantial power requirements, whether in the form of batteries or fuel, to power the motors and other operational equipment of the vehicle. As such, more energy efficient buoyant aerial vehicles are desirable.

### SUMMARY

According to one aspect of the present disclosure, a buoyant aerial vehicle system is provided and includes a balloon configured to store a gas, a ballonet configured to selectively receive and discharge a gas to adjust the altitude of the balloon, and an energy regeneration assembly coupled to the ballonet. The energy regeneration assembly includes a turbine and an electric motor operably coupled to the turbine. The turbine is coupled to an outlet of the ballonet, such that gas released by the bayonet activates the turbine. The electric motor is configured to convert mechanical energy received from the turbine into electrical energy and convey the electrical energy to a battery of the system.

In aspects, the turbine may include a rotatable wheel and an axle non-rotatably coupled to the wheel. The axle may extend through the electric motor.

In aspects, the electric motor may include a magnetic rotor non-rotatably coupled to the axle, such that a rotation of the wheel results in a rotation of the magnetic rotor.

In aspects, the electric motor may include an electrical stator disposed about the magnetic rotor. The magnetic rotor may be configured to rotate within and relative to the electrical stator.

In aspects, the turbine may have a plurality of vanes extending radially outward from the wheel. The vanes may be configured to rotate about a longitudinal axis defined by the axle upon gas releasing from the ballonet.

In aspects, the system may further include a controller configured to direct the electrical energy to a battery.

In aspects, the system may further include a compressor in fluid communication with the ballonet for supplying compressed air to an interior of the ballonet.

In aspects, the compressor may be operably coupled to the electric motor.

In aspects, the compressor may be powered by the electric motor.

In aspects, wheel may be non-rotatably coupled to a first end of the axle and the compressor may be non-rotatably coupled to a second end of the axle.

In aspects, the electric motor may include a magnetic rotor non-rotatably coupled to the axle at a location between the wheel and the compressor, such that the magnetic rotor, the wheel, and the compressor rotate together.

In another aspect of the present disclosure, a buoyant aerial vehicle system is provided and includes a balloon configured to store a gas, a payload coupled to the balloon, a ballonet configured to selectively receive and discharge a gas to adjust the altitude of the payload, and an energy regeneration assembly. The energy regeneration assembly includes a turbine, a compressor, and an electric motor operably coupled to the turbine. The turbine is in fluid communication with a passageway of the ballonet, such that gas released by the ballonet activates the turbine. The compressor is in fluid communication with the passageway of the ballonet for supplying compressed gas to the ballonet. The electric motor is configured to power the compressor and convert mechanical energy received from the turbine into electrical energy and convey the electrical energy to a battery.

Further details and aspects of exemplary embodiments of the present disclosure are described in more detail below with reference to the appended figures.

### BRIEF DESCRIPTION OF THE DRAWINGS

Various aspects and features of the present systems and methods are described herein below with references to the drawings, wherein:

FIG. 1 is a schematic diagram of an illustrative aerial vehicle system, in accordance with an embodiment of the present disclosure;

FIG. 2 is a front view of a balloon, a ballonet, and an energy regeneration assembly of the system of FIG. 1;

FIG. 3 is an enlarged cross-section, taken along line 3-3 in FIG. 2, of the energy regeneration assembly; and

FIG. 4 is another embodiment of an energy regeneration assembly for use in the system of FIG. 1.

### DETAILED DESCRIPTION

The present disclosure is directed to buoyant aerial vehicle systems capable of controlled flight. The buoyant aerial vehicle systems include a balloon containing a lifting gas that has a lower density than air, and a ballonet for adjusting the altitude of the balloon. To lower the balloon, the ballonet is inflated with a suitable amount of compressed gas, thereby increasing the overall density of the air in the balloon. To raise or lift the balloon, the ballonet is deflated by releasing a suitable amount of the gas, thereby decreasing the overall density of the air in the balloon. The buoyant aerial vehicle systems of the present disclosure implement an energy regeneration assembly for recapturing energy that would otherwise be lost during the ballonet's release of the gas during descent. The energy regeneration assembly includes a turbine that absorbs the mechanical energy in the gas being discharged from the ballonet, and an electric motor that converts the mechanical energy received from the turbine into electrical energy. The electrical energy may then be conveyed to a battery or batteries of the system for later use. In some embodiments, the air compressor, the turbine, and the electric motor may be constructed as an integral unit disposed within the outlet of the ballonet.

Although the present disclosure makes particular reference to super-pressure balloons, which are designed to float at an altitude in the atmosphere where the density of the balloon system is equal to the density of the atmosphere, this is being used for illustrative purposes only. The energy regeneration assembly according to the present disclosure may be used with any vehicle that maintains altitude at least in part by using buoyancy, such as other types of balloons, airships, and the like.

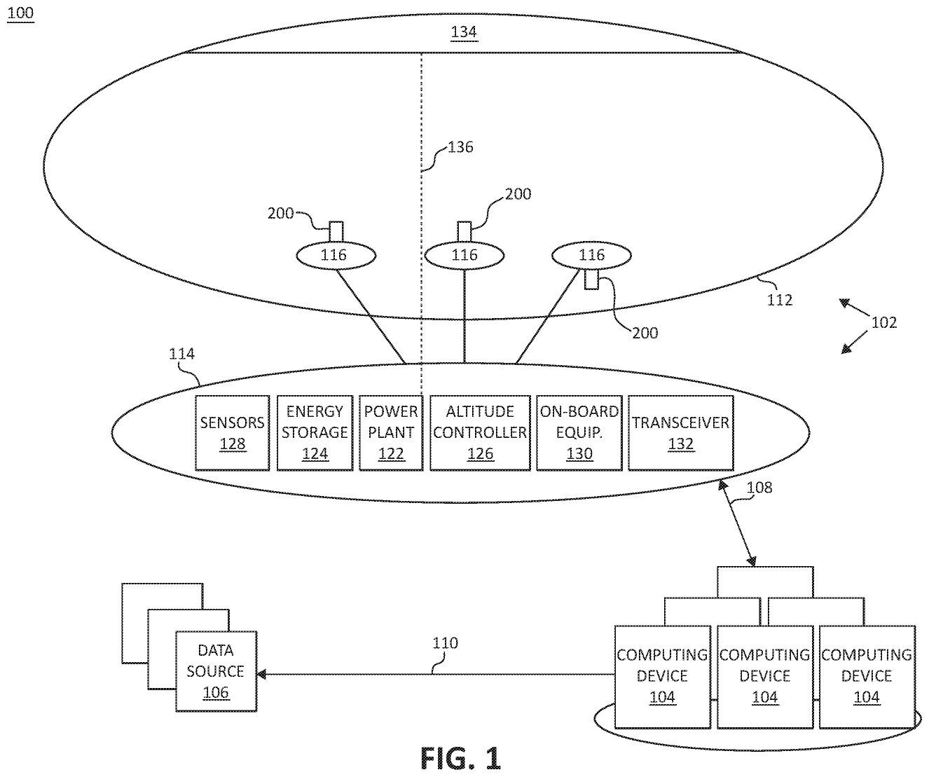

With reference to FIG. 1, an illustrative aerial vehicle system 100 is illustrated and generally includes an aerial vehicle 102, one or more computing devices 104, and one or more data sources 106. Although FIG. 1 shows a particular type of aerial vehicle 102, this is not intended to limit the scope of the present disclosure. The aerial vehicle 102 and the computing devices 104 are communicatively coupled to one another by way of a wireless communication link 108, and the computing devices 104 and the data sources 106 are communicatively coupled to one another by way of wired and/or wireless communication link 110. In some aspects, the aerial vehicle 102 is configured to be launched into and moved about the atmosphere, and the computing devices 104 cooperate as a ground-based distributed array to perform their functions described herein. The data sources 106 may include airborne data sources, such as airborne weather balloons, additional airborne aerial vehicles 102, and/or the like, and/or ground-based data sources, such as publicly available and/or proprietary databases, examples of which are the Global Forecast System (GFS) operated by the National Oceanic and Atmospheric Administration (NOAA), as well as databases maintained by the European Center for Medium-range Weather Forecasts (ECMWF).

Although the present disclosure is provided in the context of an embodiment where the system 100 includes multiple computing devices 104 and multiple data sources 106, in other embodiments the system 100 may include a single computing device 104 and a single data source 106. Further, although FIG. 1 shows a single aerial vehicle 102, in various embodiments the system 100 includes a fleet of multiple aerial vehicles 102 that are positioned at different locations throughout the atmosphere and that are configured to communicate with the computing devices 104, the data sources 106, and/or one another by way of the communication links 108 and/or 110.

In various embodiments, the aerial vehicle 102 may be configured to perform a variety of functions or provide a variety of services, such as, for instance, telecommunication services (e.g., Long Term Evolution (LTE) service), hurricane monitoring services, ship tracking services, services relating to imaging, astronomy, radar, ecology, conservation, and/or other types of functions or services. Computing devices 104 control the position (also referred to as location) and/or movement of the aerial vehicles 102 throughout the atmosphere or beyond, to facilitate effective and efficient performance of their functions or provision of their services, as the case may be. The computing devices 104 are configured to obtain a variety of types of data from a variety of sources and, based on the obtained data, communicate messages to the aerial vehicle 102 to control its position and/or movement during flight.

With continued reference to FIG. 1, the aerial vehicle 102 includes a lift gas balloon 112, one or more ballonets 116, and a payload or gondola 114, which is suspended beneath the lift gas balloon 112 and/or the ballonets 116 while the aerial vehicle 102 is in flight. The ballonets 116 may be used to control the buoyancy, and therefore the altitude, of the aerial vehicle 102 during flight. The ballonets 116 include air and the lift gas balloon 112 includes a lifting gas that is less dense (i.e., lighter) than air. The ballonets 116 may be positioned inside the lift gas balloon 112, as shown in FIG. 1, and/or outside the lift gas balloon 112.

The system 100 includes a vehicle controller 126 configured for controlling the amount of air in the ballonets 116 to adjust the buoyancy of the aerial vehicle 102 to assist in controlling its position and/or movement during flight. In various embodiments, the vehicle controller 126 is configured to control the ballonets 116 based at least in part upon an altitude command that is generated by, and received from, the computing devices 104 by way of the wireless communication link 108 and the transceiver 132.

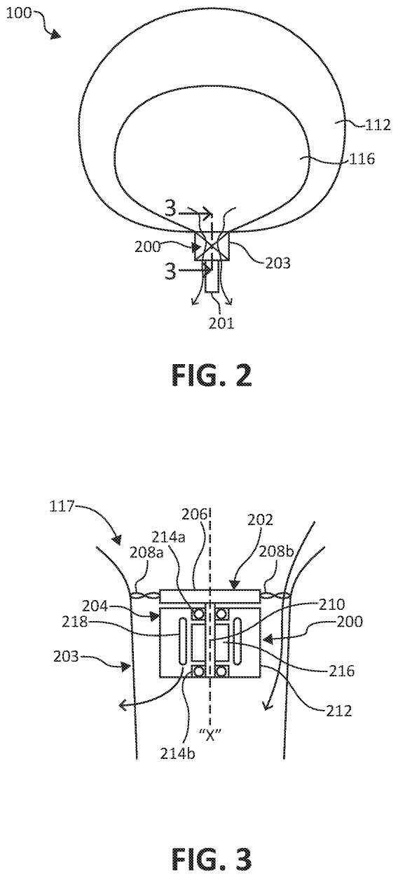

The vehicle controller 126 controls a pump and a valve (neither of which are explicitly shown) to pump air into the ballonet 116 (from air outside the aerial vehicle 102) to increase the mass (i.e., density) of the aerial vehicle 102 and lower its altitude. Additionally, the vehicle controller 126 may direct the pump and valve to release air from the ballonets 116 (into the atmosphere outside the aerial vehicle 102) to decrease the mass of the aerial vehicle 102 and increase its altitude. The system may include an air compressor 202 (FIG. 2) in fluid communication with the ballonets 116 to deliver compressed gas/air into the ballonets 112. In embodiments of the system that utilize the compressor 201, the pump and valve are configured to deliver the gas to the compressor 201 upon a command executed by the controller 126, whereby the compressor 201 compresses the gas and delivers the compressed gas to the ballonet 116, as will be described in further detail below. The combination of the vehicle controller 126, the valves and pumps (not shown in FIG. 1), and the compressor 201 is referred to as an air-gas altitude control system (ACS).

The aerial vehicle 102 may also include one or more solar panels 134 affixed thereto. As shown in FIG. 1, the solar panels 134 may be affixed to an upper portion of the lift gas balloon 112 that converts sunlight, when available, into electrical energy. Alternatively, or in addition, the solar panels 134 may be affixed to the gondola 114 or elsewhere to aerial vehicle 102 (not shown in FIG. 1). The solar panels 134 provide, by way of power paths such as power path 136, the generated electrical energy to the various components of the aerial vehicle 102, such as components housed within the gondola 114, for utilization during flight.

The gondola 114 includes a variety of components, some of which may or may not be included, depending upon the application and/or needs of the aerial vehicle 102. Although not expressly shown in FIG. 1, the various components of the aerial vehicle 102 in general, and/or of the gondola 114 in particular, may be coupled to one another for communication of power, data, and/or other signals. The exemplary gondola 114 shown in FIG. 1 includes one or more sensors 128, an energy storage module 124, a power plant 122, a vehicle controller 126, a transceiver 132, and other on-board equipment 130. The transceiver 132 is configured to wirelessly communicate data between the aerial vehicle 102 and the computing devices 104 and/or data sources 106 by way of the wireless communication link 108 and/or the communication link 110, respectively.

In some embodiments, the sensors 128 include a global positioning system (GPS) sensor that senses and outputs location data, such as latitude, longitude, and/or altitude data corresponding to a latitude, longitude, and/or altitude of the aerial vehicle 102 in the Earth's atmosphere. The sensors 128 are configured to provide the location data to the computing devices 104 by way of the wireless transceiver 132 and the wireless communication link 108 for use in controlling the aerial vehicle 102, as described in further detail below.

The energy storage module 124 includes one or more batteries that store electrical energy provided by the solar panels 134 for use by the various components of the aerial vehicle 102. The power plant 122 obtains electrical energy stored by the energy storage module 124 and converts and/or conditions the electrical energy to a form suitable for use by the various components of the aerial vehicle 102.

The on-board equipment 130 may include a variety of types of equipment, depending upon the application or needs, as outlined above. For example, the on-board equipment 130 may include LTE transmitters and/or receivers, weather sensors, imaging equipment, and/or any other suitable type of equipment.

With reference to FIGS. 2 and 3, the energy regeneration assembly 200 of the buoyant aerial vehicle system 100 will now be described in detail. The energy regeneration assembly 200 is disposed within the ACS and in fluid communication with a passageway or outlet 117 of the ballonet 116. In embodiments, the energy regeneration assembly 200 may be disposed within the passageway 117 of the ballonet 116. In embodiments where multiple ballonets 116 are used, a discrete energy regeneration assembly 200 may be provided in each. The energy regeneration assembly 200 generally includes a turbine 202 aligned with an exhaust path of the ballonet 116, and an electric motor or generator 204 operably coupled to the turbine 202. As will be described in detail below, when the valve (not shown) of the ACS is opened, the gas stored in the ballonet 116 is allowed to freely exhaust out of the ballonet 116, due to the high internal pressure of the balloon 112 and/or ballonet 116 relative to the ambient environment, causing the turbine 202 to rotate, thereby activating the electric motor 204.

The turbine 202 includes a rotatable wheel 206 and a plurality of vanes or blades 208a, 208b extending radially outward from the wheel 206. The vanes 208a, 208b are circumferentially spaced from one another about the wheel 206. The vanes 208a, 208b are configured effect a rotation of the wheel 206 upon air passing out of the outlet 117 in the direction indicated by arrow “A” in FIG. 3. In embodiments, the turbine 202 may be of any suitable construction that allows for rotation of the turbine 202 as the gas released from the ballonet 116 passes by. An axle or drive shaft 210 is fixed to the wheel 206 and is rotationally supported in a housing 212 of the electric motor 204. In this way, the axle 210 rotates concomitantly with a rotation of the wheel 206. The axle 210 may have a pair of bearings 214a, 214b disposed on opposing first and second ends thereof to facilitate rotation of the axle 210 within the housing 212 of the electric motor 204.

With continued reference to FIGS. 2 and 3, the electric motor 204 is configured to convert mechanical energy received from the turbine 202 into electrical energy. In particular, the electric motor 204 includes a magnetic rotor 216 disposed about and non-rotatably coupled to the axle 210, and an electrical stator 218 disposed about the magnetic rotor 216. In some embodiments, the electric motor 204 may be any suitable type of generator for converting mechanical energy into electrical energy. The electrical stator 218 is rotationally fixed within the housing 212 of the electric motor 204, whereas the magnetic rotor 216 is configured to rotate with the axle 210 of the turbine 202 relative to and within the electrical stator 218. A rotation of the magnetic rotor 216, via the turbine 202, induces the flow of electrons in the electrical stator 218. The electrical stator 218 is electrically coupled to the energy storage module 124 (FIG. 1), such that during use, the electrical stator 218 conveys the electrical energy generated by the electric motor 204 to the batteries in the energy storage module 124.

In operation, to increase the altitude of the system 100, the controller 126 directs the valve of the ACS to open, whereby gas within the ballonet 116 is forced through the outlet 117 of the ballonet 116 due to the relatively high internal pressure within the ballonet 116. As the gas passes over the vanes 208a, 208b of the turbine 202 of the energy regeneration assembly 200, the wheel 206 and the attached axle 210 rotate about a longitudinal axis “X” defined by the axle 210. Since the magnetic rotor 216 of the electric motor 204 is fixed relative to the axle 210, rotation of the axle 210 causes the magnetic rotor 216 to rotate within and relative to the electrical stator 218. Rotation of the magnetic rotor 216 induces electrons to flow in the electrical stator 218. The electricity generated in the electrical stator 218 of the electric motor 204 may be directed, via a command from the controller 126, to the batteries in the energy storage module 124. As such, the potential energy stored in the ballonet 116, which is converted to mechanical energy in the form of gas discharging from the ballonet 116 during ascent, is converted into electrical energy and stored for later utilization by the system 100.

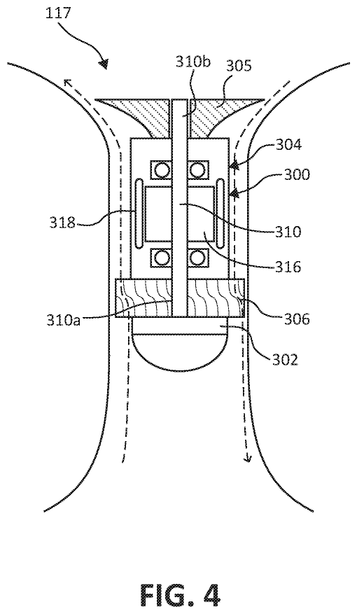

With reference to FIG. 4, another embodiment of an energy regeneration assembly 300 for use with the buoyant aerial vehicle system of FIG. 1 is provided. Due to the similarities between the energy regeneration assembly 300 of the present embodiment and the energy regeneration assembly 200 described above, only those elements of the energy regeneration assembly 300 deemed necessary to elucidate the differences from the energy regeneration assembly 200 described above will be described in detail.

In contrast to the energy regeneration assembly 200 of FIGS. 2 and 3, the energy regeneration assembly 300 of the present embodiment includes a turbine 302, an electric motor 304, and a compressor 305 constructed as an integral unit. Forming the energy regeneration assembly 300 as an integral unit reduces its cost, complexity, and lowers the overall power budget for the system 100. The turbine 302 includes a wheel 306 and an axle or shaft 310 extending through the electric motor 304. The turbine 302 is non-rotatably coupled to a first end 310a of the axle 310, and the compressor 305 is non-rotatably coupled to a second end 310b of the axle 310. The electric motor 304 is configured to convert mechanical energy from the turbine 302 into electrical energy using a magnetic rotor 316 disposed about the axle 310, and a stationary electrical stator 318 disposed about the magnetic rotor 316.

In operation, to increase the altitude of the system 100, the controller 126 directs the valve of the ACS to open, whereby air within the ballonet 116 is forced through the outlet 117 of the ballonet 116 due to the relatively high internal pressure within the ballonet 116. As the air passes over the wheel 306 of the turbine 302, the wheel 306 and the attached axle 310 rotate about a longitudinal axis defined by the axle 310. Since the magnetic rotor 316 of the electric motor 304 is fixed relative to the axle 310, rotation of the axle 310 causes the magnetic rotor 316 to rotate within and relative to the electrical stator 318. The rotating magnetic rotor 316 induces electrons to flow in the electrical stator 318. The electricity generated in the electrical stator 318 of the electric motor 304 may be directed, via a command from the controller 126, to the batteries in the energy storage module 124. As such, the mechanical energy of the outflowing air is converted into electrical energy and stored for a later use by the system 100.

To decrease the altitude of the system 100, the controller 126 actuates the electric motor 304 of the energy regeneration assembly 300 while directing the pump of the ACS to move air (e.g., from the atmosphere) into the passageway 117 of the ballonet 116. Since the electric motor 304 is activated, the electric motor 304 drives a rotation of the compressor 305 via the axle 310, whereby the compressor 305 compresses the air prior to allowing the air to enter the interior of the ballonet 116. As the compressed air enters the ballonet 116, the density of the system 100 increases, causing the system 100 to reduce its altitude. In this way, the electric motor 304 of the energy regeneration assembly 300 functions both to activate the compressor 304 and convert mechanical energy derived from the turbine 302 into electrical energy.

The embodiments disclosed herein are examples of the present systems and methods and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present information systems in virtually any appropriately detailed structure. Like reference numerals may refer to similar or identical elements throughout the description of the figures.

The phrases “in an embodiment,” “in embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems and/or methods described herein may utilize one or more controllers to receive various data and transform the received data to generate an output. The controller may include any type of computing device, computational circuit, or any type of processor or processing circuit capable of executing a series of instructions that are stored in a memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, causes the one or more processors to perform one or more methods and/or algorithms. In exemplary embodiments that employ a combination of multiple controllers and/or multiple memories, each function of the systems and/or methods described herein can be allocated to and executed by any combination of the controllers and memories.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

Any of the herein described methods, programs, algorithms or codes may be contained on one or more non-transitory computer-readable or machine-readable media or memory. The term “memory” may include a mechanism that provides (in an example, stores and/or transmits) information in a form readable by a machine such a processor, computer, or a digital processing device. For example, a memory may include a read only memory (ROM), random access memory (RAM), magnetic disk storage media, optical storage media, flash memory devices, or any other volatile or non-volatile memory storage device. Code or instructions contained thereon can be represented by carrier wave signals, infrared signals, digital signals, and by other like signals.

The foregoing description is only illustrative of the present systems and methods. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A buoyant aerial vehicle system comprising:
a balloon configured to store a gas;
at least one ballonet configured to selectively receive and discharge a gas to adjust an altitude of the balloon; and
an energy regeneration assembly including:
a turbine coupled to an outlet of the at least one ballonet, such that gas released by the at least one bayonet activates the turbine; and
an electric motor operably coupled to the turbine, wherein the electric motor is configured to convert mechanical energy received from the turbine into electrical energy and convey the electrical energy to a battery.

2. The buoyant aerial vehicle system according to claim 1, wherein the turbine includes:
a rotatable wheel; and
an axle non-rotatably coupled to the wheel and extending through the electric motor.

3. The buoyant aerial vehicle system according to claim 2, wherein the electric motor includes a magnetic rotor non-rotatably coupled to the axle, such that a rotation of the wheel results in a rotation of the magnetic rotor.

4. The buoyant aerial vehicle system according to claim 3, wherein the electric motor includes an electrical stator disposed about the magnetic rotor, the magnetic rotor configured to rotate within and relative to the electrical stator.

5. The buoyant aerial vehicle system according to claim 2, wherein the turbine has a plurality of vanes extending radially outward from the wheel, the plurality of vanes being configured to rotate about a longitudinal axis defined by the axle upon gas releasing from the at least one ballonet.

6. The buoyant aerial vehicle system according to claim 1, further comprising a controller configured to direct the electrical energy to a battery.

7. The buoyant aerial vehicle system according to claim 1, further comprising a compressor in fluid communication with the at least one ballonet for supplying compressed air to an interior of the at least one ballonet.

8. The buoyant aerial vehicle system according to claim 7, wherein the compressor is operably coupled to the electric motor.

9. The buoyant aerial vehicle system according to claim 8, wherein the compressor is powered by the electric motor.

10. The buoyant aerial vehicle system according to claim 8, wherein the turbine includes:
a rotatable wheel; and
an axle extending through the electric motor, the wheel being non-rotatably coupled to a first end of the axle and the compressor being non-rotatably coupled to a second end of the axle.

11. The buoyant aerial vehicle system according to claim 10, wherein the electric motor includes a magnetic rotor non-rotatably coupled to the axle at a location between the wheel and the compressor, such that the magnetic rotor, the wheel, and the compressor rotate together.

12. The buoyant aerial vehicle system according to claim 11, wherein the electric motor further includes an electrical stator disposed about the magnetic rotor, the magnetic rotor configured to rotate within and relative to the electrical stator.

13. A buoyant aerial vehicle system comprising:
a balloon configured to store a gas;
a payload coupled to the balloon;
at least one ballonet configured to selectively receive and discharge a gas to adjust an altitude of the payload; and
an energy regeneration assembly including:
a turbine in fluid communication with a passageway of the at least one ballonet, such that gas released by the at least one ballonet activates the turbine;
a compressor in fluid communication with the passageway of the at least one ballonet for supplying compressed gas to the at least one ballonet; and
an electric motor operably coupled to the turbine and configured to power the compressor, wherein the electric motor is configured to convert mechanical energy received from the turbine into electrical energy and convey the electrical energy to a battery.

14. The buoyant aerial vehicle system according to claim 13, wherein the turbine includes:
a rotatable wheel; and
an axle extending through the electric motor, the wheel being non-rotatably coupled to a first end of the axle and the compressor being non-rotatably coupled to a second end of the axle.

15. The buoyant aerial vehicle system according to claim 14, wherein the electric motor includes a magnetic rotor non-rotatably coupled to the axle at a location between the wheel and the compressor, such that the magnetic rotor, the wheel, and the compressor rotate together.

16. The buoyant aerial vehicle system according to claim 15, wherein the electric motor further includes an electrical stator disposed about the magnetic rotor, the magnetic rotor configured to rotate within and relative to the electrical stator.
